(19) United States
(12) Patent Application Publication
(10) Pub. No.: US 2002/0014527 A1
(43) Pub. Date: Feb. 7, 2002

(54) Sales system using credit cards, credit card verification device, and credit card

(75) Inventor: Yoshiaki Sawada, Tokyo (JP)

Correspondence Address: Paul J. Esatto, Jr., Scully, Scott, Murphy & Presser, 400 Garden City plaza, Garden City, NY, 11530, US

(73) Assignee: NEC Corporation, Tokyo (JP)

(21) Appl. No.: 09/847,821

(22) Filed: May 2, 2001

(30) Foreign Application Priority Data
May 12, 2000 (JP) 2000-140861

(51) Int. Cl. G06K 5/00

(52) U.S. Cl. 235/380

(57) ABSTRACT

A sales system using a credit card in which a card holder presents the credit card to a business that sells goods or services. The business, after confirming the validity of the credit card, supplies the goods or services to the card holder. The sales system includes a credit card containing coded information unique to the card holder and a credit card verification device possessed by the business. The credit card verification device including a zero-knowledge verification unit based on a zero-knowledge verification system and being capable of verifying the credit card containing coded information based on the zero-knowledge verification system. Accordingly, a transaction in the sales system using the credit card is carried out without a presentation of the personal information of the card holder to the business.

### BACKGROUND OF THE INVENTION

1. Field of the Invention

The present invention relates to a sales system using credit cards, a credit card verification device, and a credit card. More specifically, the present invention relates to a sales system using credit cards for supplying goods or services to a customer, and a credit card verification device and a credit card verifiable by the verification unit, which are suitable in use for a business or a credit card company using the sales system.

2. Description of Related Art

FIG. 2 is a diagram showing a conventional sales system using a credit card and procedures for making a payment by using the credit card.

As shown in FIG. 2, payment using a credit card in the above sales system is conventionally made by the following procedures:

1. a card holder 1 presents a card number to a business 2, for instance, via an on-line circuit (Step A1);

2. the business 2 makes an inquiry to a card company 3 in order to determine the validity of the card presented by the card holder 1 (Step A2);

3. the card company 3 determines the validity of the card based on the card number and informs the business 2 of the verification result (Step A3);

4. if it is determined that the card is valid, the business 2 supplies goods or services to the card holder 1 (Step A4, Step A5);

5. the business 2 notifies the card company 3 of the card number and the amount billed (Step A6);

6. the card company 3 pays to the business 2 the amount billed (Step A7);

7. the card company 3 requests the card holder 1 to make a payment (Step A8); and

8. the card holder 1 pays the bill to the card company 3 (Step A9).

In the above-mentioned conventional payment method using a credit card, however, problems such as follows may arise.

First, the credit card holder 1 must present the card number to the business 2.

Second, the card number may be known to a third party since the number goes back and forth among the card holder 1, the business 2, and the card company 3.

That is, for instance, the business 2, having access to the card number of the card holder 1, may carry out a fraudulent transaction or leak the card number to a third party having dishonest intentions.

Accordingly, an object of the present invention is to prevent such leaks of a credit card number and to allow a customer to receive goods or services without presenting his/her credit card number.

### SUMMARY OF THE INVENTION

The present invention provides a sales system using a credit card in which a card holder presents the credit card to a business that sells goods or services, the business, after confirming the validity of the credit card, supplies the goods or services to the card holder, including: a credit card containing coded information unique to the card holder; and a credit card verification device possessed by the business, the credit card verification device comprising a zero-knowledge verification unit based on a zero-knowledge verification system and being capable of verifying the credit card containing coded information based on the zero-knowledge verification system whereby a transaction in the sales system using the credit card is carried out without presenting of the personal information of the card holder to the business.

In accordance with another aspect of the invention, the personal information includes a card number of the credit card possessed by the card holder.

In yet another aspect of the invention, the credit card verification device is possessed by a card company verifying the credit card.

The present invention also provides a credit card verification device, including: a zero-knowledge verification unit capable of verifying a credit card containing coded information unique to a card holder, wherein the zero-knowledge verification unit is based on a zero-knowledge verification system and verifies the credit card without presenting personal information of the card holder to a business that sells goods or services.

In accordance with another aspect of the invention, the personal information of the card holder described in the above credit card verification device includes a card number of the credit card possessed by the card holder.

In yet another aspect of the invention, the credit card verification device is possessed by the business that sells goods or services in a sales system using the credit card, in which the card holder presents the credit card to the business, and the business, after confirming the validity of the credit card, supplies the goods or services to the card holder.

In yet another aspect of the invention, the credit card verification device is possessed by a card company verifying the credit card in a sales system using the credit card, in which the card holder presents the credit card to the business that sells goods or services, and the business, after confirming the validity of the credit card, supplies the goods or services to the card holder.

The present invention also provides a credit card, including: coded information unique to a card holder, wherein the coded information may be decoded by a credit card verification device comprising a zero-knowledge verification unit based on a zero-knowledge verification system whereby a transaction using the credit card is carried out without presenting personal information of a card holder to a business that sells goods or services.

### BRIEF DESCRIPTION OF THE DRAWINGS

Some of the features and advantages of the invention have been described, and others will become apparent from the detailed description which follows and from the accompanying drawings, in which:

FIG. 1 is a diagram showing a sales system using a credit card and procedures for making a payment by using the credit card according to an embodiment of the present invention; and

FIG. 2 is a diagram showing a conventional sales system using a credit card and procedures for making a payment by using the credit card.

### DETAILED DESCRIPTION OF THE INVENTION

The invention summarized above and defined by the enumerated claims may be better understood by referring to the following detailed description, which should be read with reference to the accompanying diagram. This detailed description of a particular preferred embodiment, set out below to enable one to build and use one particular implementation of the invention, is not intended to limit the enumerated claims, but to serve as a particular example thereof.

The present invention makes it possible to carry out a transaction using a credit card without providing a personal information such as a card number to a business that sells goods or services (hereinafter simply referred to as a business). That is, a card holder need not present his card number to the business since the validity of the card or the identity of the card holder may be verified by a zero-knowledge verification unit.

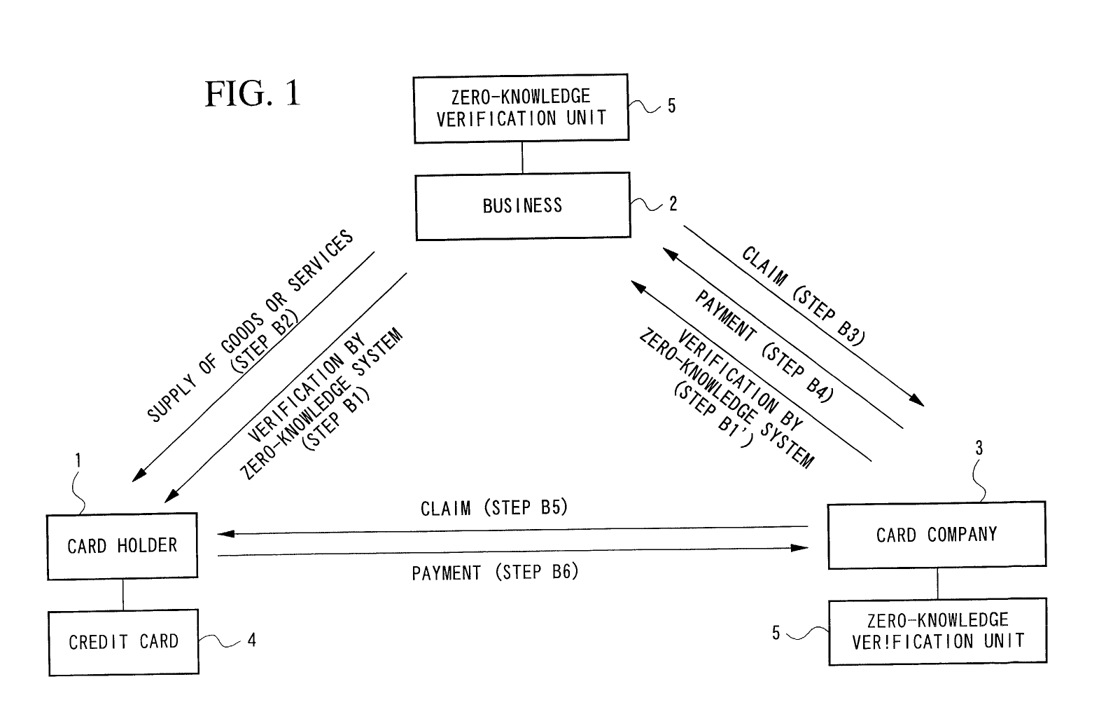

FIG. 1 is a diagram showing a sales system using a credit card and procedures for making a payment by using the credit card according to an embodiment of the present invention.

According to the sales system of the embodiment of the present invention, a card holder 1, a business 2, and a card company 3 are involved. The card holder 1 holds a credit card 4, and the business 2 and the card company 3, each, have a zero-knowledge verification unit 5 provided with a terminal device (a credit card verification device).

The card company 3 issues the credit card 4 and the credit card 4 is lent to the card holder 1. A characteristic code containing a card number which corresponds to the card holder in question is recorded in the credit card 4. The code can be restored only by the card holder 1 and the card company 3.

The zero-knowledge verification unit 5 is a unit which carries out a zero-knowledge verification process and is originally supplied by a reliable organization such as a zero-knowledge verification organization. In this embodiment of the present invention, it is assumed that the business 2 and the card company 3 possess a reliable zero-knowledge verification unit 5 and the organization which supplies the unit 5 is not particularly limited.

Also, the zero-knowledge verification unit 5 is a unit which is capable of verifying the identity of a prover (i.e., the card holder 1 in this embodiment) to a verifier (i.e., the business 2 in this embodiment) without giving any personal information of the prover to the verifier.

In general, a zero-knowledge verification system is an interactive proof system, which is a system based on a challenge-and-response type protocol, and may be used when a person (the prover) persuades somebody else (the verifier) without giving any information regarding the verification. A typical round in the protocol is constituted by a question (challenge) by the verifier and an answer (response) to the question by the prover. At the end of the protocol, the verifier determines whether to accept or reject the verification based on the answers of the prover to the questions of the verifier. One of the characteristics of the zero-knowledge verification system is that the verifier cannot prove by himself the answer of the prover even after the protocol is finished.

The zero-knowledge verification system may be explained by the following example of a graph isomorphism type.

Input: graphs G₁ and G₂ having a set {1, . . . , n}

1. repeat steps 2-5 for n times;

2. the prover chooses a permutation π randomly. Calculate the image of G₁ to which the permutation π is applied as H and sends H to the verifier;

3. the verifier chooses i=1 or 2 at random and sends it to the prover;

4. the prover calculates a permutation ρ of {1, . . . , n} so that the image of Gi to which ρ is applied becomes H. The prover sends ρ to the verifier (if i=1, then the prover sets ρ=π. If i=2, then the prover defines ρ as a synthesis of σ and π. Here, σ is a certain fixed permutation which makes the image of G₂ equal to G₁;

5. the verifier confirms whether H is the image of Gi to which ρ is applied; and

6. if H is the image of Gi for all of the rounds which are carried out for n times, the verifier accepts the verification of the prover.

Assume G₁=(V, E₁) and G₂=(V, E₂). Here, V={1, 2, 3, 4}, E₁={12, 13, 14, 34}, and E₂={12, 13, 23, 24}. Isomorphism from G₂ to G₁ is a permutation σ=(4132). Assume that the prover chooses a permutation π=(2413) at a certain round, then H has a branch set {12, 13, 23, 24}.

If the question of the verifier is i=1, then the prover gives a permutation π to the verifier and the verifier confirms that the image of G₁ is H. If the question of the verifier is i=2, then the prover gives the verifier ρ=π∘σ=(3214) and the verifier confirms that the image of G₂ to which ρ is applied is H.

The completeness and the soundness of this protocol can be confirmed easily. If G₁ is isomorphic to G₂, then it is understood that the odds that the verifier accepts is 1. On the other hand, if G1 is not isomorphic to G2, then the only way for the prover to cheat the verifier is to correctly guess the value of i for all the rounds and write a (random) isomorphic image of Gi. The probability that the prover will correctly answer the random questions of the verifier n times is 2⁻ⁿ.

The above verification system is called the zero-knowledge verification system because even if the verifier agrees that G₁ is isomorphic to G₂, he cannot have any “knowledge” which can be of help to find the permutation σ from G₁ to G₂. At each round of the verification, the verifier can obtain only G₁, H which is a random isomorphic image of G₂, and a permutation from one of G₁ and G₂ to H.

The zero-knowledge verification unit 5 according to an embodiment of the present invention is a unit including information based on the above-mentioned zero-knowledge verification system and makes it possible to determine the validity of the credit card 4 of the card holder 1 for the business 2 without giving any personal information of the card holder 1 to the business 2. The zero-knowledge verification unit 5 may be provided with a terminal device so as to be used as a credit card verification device according to an embodiment of the present invention.

Also, the credit card 4 according to an embodiment of the present invention may be made of any kind of materials or can be of any suitable shape as long as it can contain information decodable by the zero-knowledge verification unit 5 according to an embodiment of the present invention. The decoded information may be recorded in the credit card 4 by using any suitable recording means.

Next, payment procedures using a credit card according to an embodiment of the present invention will be described in detail.

As shown in FIG. 1, when the card holder 1 purchases goods or services of the business 2, the card holder 1 presents information (i.e., coded information) of the credit card 4 to the business 2. The business 2 confirms that the credit card 4 was actually issued by the card company 3 by using the zero-knowledge verification unit 5. The verification procedure of the credit card 4 may also be carried out between the business 2 and the card company 3 using the zero-knowledge verification unit 5 (Step B1).

As mentioned above, the zero-knowledge verification unit 5 makes it possible to carry out a verification procedure without giving any personal information of the prover to the verifier. That is, in this embodiment of the present invention, it is possible for the business 2 to obtain verification that the credit card 4 is a valid card issued by the card company 3 without giving information such as the personal credit card number of the card holder 1.

Moreover, by using the zero-knowledge verification unit 5, the business 2 cannot identify a card holder (or obtain a card number) from the coded information of the credit card 4. Accordingly, the business 2 cannot use the card number for dishonest intents.

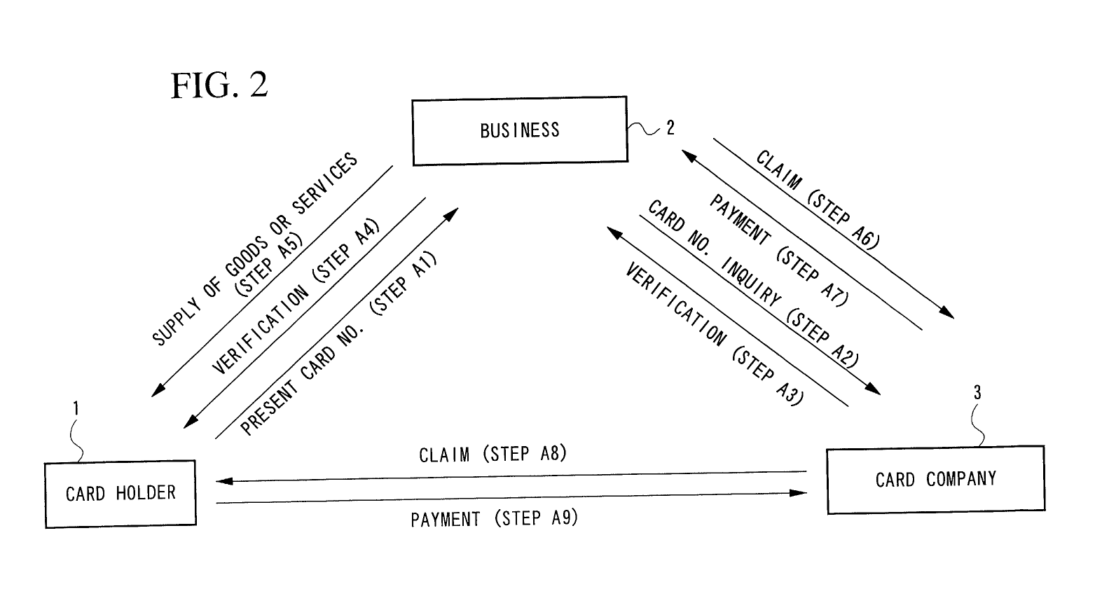

Further, the problems associated with the conventional method shown in FIG. 2 may be solved. That is, conventionally, a card number is presented to the business 2 by the card holder 1 (Step A1) and then the card number is presented to the card company 3 by the business 2 (Step A2) as uncoded text. Accordingly, the card number may be learned by a third party. This kind of problem may be solved by an embodiment according to the present invention.

The business 2, after confirming the verification of the card 4, supplies goods or services to the card holder 1 (Step B2). Then, the business 2 transfers information (i.e., coded information) of the credit card 4, which was used upon verification of the card 4, to the card company 3. The card company 3 verifies the information of the credit card 4 by using the zero-knowledge verification unit 5 and decodes the coded information in order to specify the card holder 1.

The subsequent procedures are basically the same as the ones conventionally carried out. That is, the business 2 claims to the card company 3 an amount billed (Step B3), the card company 3 pays to the business 2 the amount billed (Step B4), the card company 3 requests the card holder 1 to make a payment (Step B5), and the card holder 1 pays the bill to the card company 3 (Step B6). In this manner, payment by the card holder 1 to the business 2 using the credit card 4 issued by the credit company 3 is made.

Having thus described exemplary embodiments of the invention, it will be apparent that various alterations, modifications, and improvements will readily occur to those skilled in the art. Such alterations, modifications, and improvements, though not expressly described above, are nonetheless intended and implied to be within the spirit and scope of the invention. Accordingly, the foregoing discussion is intended to be illustrative only; the invention is limited and defined only by the following claims and equivalents thereto.

1. A sales system using a credit card in which a card holder presents said credit card to a business that sells goods or services, said business, after confirming the validity of said credit card, supplies the goods or services to said card holder, comprising:
a credit card containing coded information unique to said card holder; and
a credit card verification device possessed by said business, said credit card verification device comprising a zero-knowledge verification unit based on a zero-knowledge verification system and being capable of verifying said credit card containing coded information based on the zero-knowledge verification system whereby
a transaction in said sales system using said credit card is carried out without presenting said personal information of said card holder to said business.

2. A sales system using a credit card according to claim 1, wherein said personal information includes a card number of said credit card possessed by said card holder.

3. A sales system using a credit card according to claim 1, wherein said credit card verification device is possessed by a card company verifying said credit card.

4. A credit card verification device, comprising:
a zero-knowledge verification unit capable of verifying a credit card containing coded information unique to a card holder, wherein
said zero-knowledge verification unit is based on a zero-knowledge verification system and verifies said credit card without presenting personal information of said card holder to a business that sells goods or services.

5. A credit card verification device according to claim 4, wherein said personal information includes a card number of said credit card possessed by said card holder.

6. A credit card verification device according to claim 4, wherein
said credit card verification device is possessed by said business that sells goods or services in a sales system using said credit card, in which said card holder presents said credit card to said business, said business, after confirming the validity of said credit card, supplies the goods or services to said card holder.

7. A credit card verification device according to claim 4, wherein
said credit card verification device is possessed by a card company verifying said credit card in a sales system using said credit card, in which said card holder presents said credit card to said business that sells goods or services, said business, after confirming the validity of said credit card, supplies the goods or services to said card holder.

8. A credit card, comprising:
coded information unique to a card holder, wherein
said coded information may be decoded by a credit card verification device comprising a zero-knowledge verification unit based on a zero-knowledge verification system whereby
a transaction using said credit card is carried out without presenting personal information of a card holder to a business that sells goods or services.
